(19) United States
(12) Patent Application Publication
(10) Pub. No.: US 2005/0086428 A1
(43) Pub. Date: Apr. 21, 2005

(54) Magnetic tape unit

(75) Inventor: Yukio Taniyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/808,350

(22) Filed: Mar. 25, 2004

(30) Foreign Application Priority Data
Oct. 16, 2003 (JP) 2003-356180

(51) Int. Cl. G06F 12/00

(52) U.S. Cl. 711/111

(57) ABSTRACT

The present invention relates to a magnetic tape unit to which a cartridge having a magnetic tape therein is detachably attached and which accesses a magnetic tape in accordance with an access request from a host. Software of the host which accesses a conventional magnetic tape unit to which a cartridge accommodating a plurality of cartridges is attached is used as it is while using the cartridge accommodating a large-capacity magnetic tape. Management information of a plurality of volumes is written in the cartridge, and a LOAD command from the host is replaced by a command for accessing an actual cartridge.

### BACKGROUND OF THE INVENTION

1. Field of the Invention

The present invention relates to a magnetic tape unit to which a cartridge having a magnetic tape therein is detachably attached and which accesses a magnetic tape in accordance with an access request from a host.

2. Description of the Related Art

A magnetic tape unit used in an electronic computer is mainly used for backup. This is because, although the magnetic tape unit can be used for exchanging or saving information, the magnetic tape medium is generally inexpensive and large-capacity medium and it is important to temporarily save the information such as data in another inexpensive large-capacity medium like the magnetic tape in the event a failure occurs in an on-line file of a disk device.

For saving information such as data in the disk device for backup, information is saved in the tape on a file-by-file basis or on a volume-by-volume basis in which a plurality of files are handled as one. A file is a set of data from some MB to some GB. A volume normally comprises a plurality of files or a single file and has a set of data of some GB. The maximum capacity of the magnetic tape is increasing every year and currently, one volume of a disk is accommodated in one magnetic tape. However, the capacity of the magnetic tape increases due to technical superiority, and if one volume of a disk is saved in one magnetic tape, only a part of the magnetic tape is used in some cases. Hence, it is necessary to increase a capacity of a file to form a file accommodating two or more volumes of a disk and the file is saved in one magnetic tape, or to increase the number of files to be saved in one magnetic tape while remaining the capacity of the file as it is.

FIG. 1 illustrates a tape format of a single file.

This format is a known standard format defined in JIS/ISO and the like. The top VOL is a block consisting of 80 bytes, and a volume name, an owner's name and the like are written therein. The VOL is written only once in the top of the magnetic tape, and the volume name is used as an ID representing that magnetic tape. One volume name is allocated to one magnetic tape. Each of HDR1 and EOF1 is a block consisting of 80 bytes, and a file name, a prepared date (year, month and-date) and the like are written. A record format, a record length and the like are written in each of HDR2 and EOF2. DATAs are areas which are written between HDR1/HDR2 and EOF1/EOF2, and a user data is stored therein. HDR1/HDR2 are used in the top of the file, and EOF1/EOF2 is used in the rear end (last) of the file.

FIG. 2 illustrates an example of a tape format of a multi-file.

When the number of files is two or more, as shown in FIG. 2, HDR1/HDR2 are written after EOF1/EOF2, DATAs are written thereafter, and EOF1/EOF2 are written. Two tape marks (shown with vertical lines in FIG. 2) are written in the last of the volume.

In order to increase a file size under such a format, it is necessary to increase a block size of the DATA sections or to increase the number of blocks. In order to increase the volume size, it is necessary to increase the size of each file, or to add two or more files to increase the number of files as shown in FIG. 2.

In some cases, enormous amounts of files or volumes may already exist on a disk system and it is not easy to change the size of the files or volumes. There is also a case in which even if it is possible to change the description of software to save many files in one magnetic tape, the amount of change increases, the maintenance thereafter increases and management cost of the computer is increased.

Thereupon, patent Japanese Patent Application Laid-open No. 09-69028 shows a conception of a virtual tape (logic volume division), and proposes an efficient way to find (use) an unused region of a tape medium.

It is described in patent Japanese Patent Application Laid-open No. 09-161450 that a cartridge for accommodating a magnetic tape includes a cartridge memory in addition to the magnetic tape.

Patent Japanese Patent Application Laid-open No. 05-54551 describes a method of realizing a general virtual tape system.

Magnetic tape units can be broadly divided into two types. In one of the types, one magnetic tape is set in a magnetic tape unit and the magnetic tape is accessed, and when it becomes necessary to access another magnetic tape, the former magnetic tape which is set in the magnetic tape unit is replaced by such an another magnetic tape. In the other type, a plurality of cartridges in each of which magnetic tape is accommodated are set in a magazine, the magazine is set in a magnetic tape unit, and the plurality of cartridges in the magazine are taken out one-by-one and accessed in the magnetic tape unit. The latter type is suitable for backup of large-capacity data.

FIG. 3 illustrates a cartridge magazine.

This cartridge magazine 10 can accommodate five cartridge tapes 20. The cartridge magazine 10 is provided at its upper section with a handle 11 so that the cartridge magazine 10 can be carried in a state in which the five cartridges are accommodated therein. The cartridge magazine 10 includes a lock mechanism 12 so that the cartridges 20 do not fall easily. Although the cartridge magazine 10 accommodates five cartridges 20 as shown in FIG. 3, the cartridge magazine 10 may accommodate ten, fifteen or twenty cartridges. By processing the cartridges 20 from upper stage in the order, the plurality of cartridges can be processed collectively.

According to this magazine, commands are issued by a host (operating software) in the following procedure, and it is possible to collectively write (or read) over the plurality of cartridges.

(1) The magazine 10 is attached to the magnetic tape unit.

Here, the magazine 10 is attached to the magnetic tape unit by operator's manual operation.

(2) A load magazine command is issued.

With this command, a first cartridge is loaded.

(3) A target cartridge is loaded by a load display command, a writing operation or a reading operation is executed by instructions from the host.

(4) An unload command is issued.

With this command, a processed cartridge is discharged into the magazine, and a next cartridge is loaded.

(5) Operations (3) and (4) are repeated.

(6) An eject command instead of the unload command is issued for the last cartridge.

With this command, the last cartridge is discharged into the magazine, and the magazine can be detached.

As described above, the storage capacity of one magnetic tape is extremely increased in recent years. Formerly, one volume is stored in one magnetic tape, but recently, data of two or more volumes is stored in one large-capacity magnetic tape, and a conception of the virtual tape as shown in patent JP-A Nos. 09-69028 and 05-54551 is introduced.

If the conception of the virtual tape is employed, software which operates in a computer using this magnetic tape unit can access one large-capacity magnetic tape by exactly the same processing as the conventional processing to access one magnetic tape.

However, there has not yet been realized a magnetic tape unit which emulates a conventional magnetic tape unit suitable for backup of large-capacity data in which one large-capacity magnetic tape is physically used, a plurality of cartridges are accommodated in the magazine, the magazine is set in the magnetic tape unit as it is, the plurality of cartridges in the magazine are taken out one-by-one, the magnetic tape is accessed, and these operations are repeated.

### SUMMARY OF THE INVENTION

The present invention has been accomplished in view of the above circumstances, and it is an object of the invention to provide a magnetic tape unit using a large-capacity magnetic tape, in which the magnetic tape unit can be used as it is without changing its program by a user who used a conventional magazine attaching type magnetic tape unit.

To achieve the above object, the present invention provides a magnetic tape unit to which a cartridge accommodating a magnetic tape is detachably attached and which accesses the magnetic tape in accordance with an access request from a host, wherein

the cartridge accommodates the magnetic tape and includes a cartridge memory which stores information in a nonvolatile and rewritable manner,

the magnetic tape unit comprising:

a magnetic tape drive which accesses the magnetic tape;

a memory read/writer for accessing the cartridge memory; and

an access-controlling section which allows the cartridge memory to store management information of a plurality of volumes using the memory read/writer, and in which based on this management information, a LOAD command of the cartridge from the host is replaced by a command for accessing a region corresponding to a volume of a virtual cartridge which receives the LOAD command from the host in the magnetic tape accommodated in an actual cartridge loaded in this magnetic tape unit, the access-controlling section allowing the magnetic tape drive to access the magnetic tape accommodated in the actual cartridge.

According to the present invention, the LOAD command from the host is-replaced by the command for accessing the actual cartridge. The host uses, as it is, the software which sequentially loads the plurality of cartridges accommodated in the magazine to access the cartridge, and the host can store data in the large-capacity magnetic tape and read the data therefrom. Here, since the management information of the plurality of volumes corresponding to the plurality of virtual cartridges to be accessed by the host is stored in the cartridge memory of the actual cartridge, the above replacement can smoothly be realized.

In the magnetic tape unit of the present invention, it is preferable that the access-controlling section remains a state in which the magnetic tape is loaded in the actual cartridge in accordance with an UNLOAD command of the cartridge from the host, and the access-controlling section brings this state into a state in which the actual cartridge can be taken out in accordance with an EJECT command from the host.

The UNLOAD command is a command for subjecting a loaded cartridge to a pre-processing such as rewinding and then for accommodating the cartridge in the magazine in the conventional technique. The EJECT command is a command for bringing the magazine into a state in which the magazine can be taken out.

Therefore, it is preferable here that with the UNLOAD command, the actual cartridge is remained in its loaded state, thereby swiftly processing the next LOAD command, and the actual cartridge is brought into a state in which the actual cartridge can be taken out in accordance with the EJECT command.

Alternatively, in the magnetic tape unit of the present invention, it is preferable that the access-controlling section remains a state in which the magnetic tape is loaded in the actual cartridge until the number of UNLOAD commands from the host reaches a predetermined value, and the access-controlling section brings this state into a state in which the actual cartridge can be taken out if the number of UNLOAD commands from the host reaches the predetermined value.

In the conventional magazine, a physically determined number of cartridges suitable for the magazine are accommodated. If the number of UNLOAD commands reaches the predetermined value, this means that all cartridges in the magazine are accessed, and if the number of UNLOAD commands reaches the predetermined number, the actual cartridge may be brought into the state in which the actual cartridge can be taken out.

As explained above, according to the present invention, software of the host which accesses a conventional magnetic tape unit to which a cartridge accommodating a plurality of cartridges is attached is used as it is while using the cartridge accommodating a large-capacity magnetic tape.

### BRIEF DESCRIPTION OF THE DRAWINGS

FIG. 1 illustrates a tape format of a single file;

FIG. 2 illustrates an example of a tape format of a multi-file;

FIG. 3 illustrates a cartridge magazine;

FIG. 4 illustrates an outward appearance of a system including a magnetic tape unit;

FIG. 5 is a block diagram of hardware of the magnetic tape unit whose outward appearance is shown in FIG. 4;

FIG. 6 illustrates contents of cartridge memory (CM) which is read and written in a program shown in FIGS. 7 to 9;

FIG. 7 is a flowchart of an initializing processing program which is executed by a CPU in an I/O section shown in FIG. 5;

FIG. 8 is a flowchart of a data writing processing program in which data is written into a magnetic tape;

FIG. 9 is a flowchart of a data reading processing program in which data is read from the magnetic tape; and

FIG. 10 is a partial flowchart that can be employed instead of steps a10 and a11 of the initializing processing program shown in FIG. 7.

### DESCRIPTION OF THE PREFERRED EMBODIMENT

An embodiment of the present invention will be described below.

FIG. 4 illustrates an outward appearance of a system including a magnetic tape unit.

A computer 100 plays a role as a host with respect to a magnetic tape unit 200.

The computer 100 includes: a body section 101 in which a CPU (central processing unit), a RAM (random access memory), a hard disk drive are incorporated; a display section 102 for displaying images and characters on a display screen 102a by instructions of the body section 101; a keyboard 103 through which a user inputs instructions to the computer 100; and a mouse 104 which designates an arbitrary position on the display screen 102a and inputs instructions in accordance with an icon displayed on that position at the time of designation.

The body section-101 further includes an FD loading-opening 101a and a CD-ROM loading-opening 101b into which a flexible disk (FD) (not shown) and a CD-ROM (not shown) are loaded respectively. An FD drive and a CD-ROM drive are also incorporated into the FD loading-opening 101a and the CD-ROM loading-opening 101b for driving and accessing the FD and the CD-ROM loaded from the loading-openings 101a and 101b.

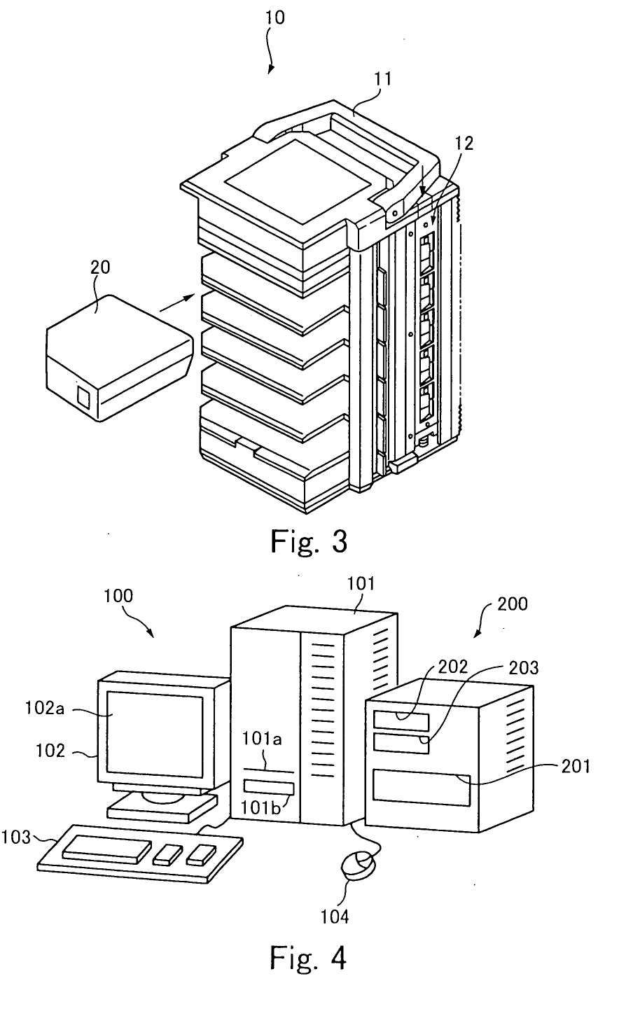

The magnetic tape unit 200 includes a cartridge loading-opening 201 into which a cartridge (see cartridge 20 shown in FIG. 3 although its storage capacity is different) is loaded. A large-capacity magnetic tape is accommodated in the cartridge. The magnetic tape unit 200 also includes a display section 202 and an operating section 203. A number of volume which is currently accessed is displayed on the display section 202. Operation buttons operated by an operator when a desired volume is to be accessed manually or a loaded cartridge is to be taken out are arranged on the operating section 203.

In the magnetic tape unit 200 shown in FIG. 4, structurally, only one cartridge in which one magnetic tape is accommodated is loaded. However, this magnetic tape unit 200 is a unit which emulates a conventional magnetic tape unit in which a magazine (magazine 10 in FIG. 3 for example) having a plurality of cartridges is attached and the plurality of cartridges are accessed in succession. In the magnetic tape unit shown in FIG. 4, display and operation are carried out based on an image that the plurality of cartridges accommodated in the magazine is loaded one-by-one from the magazine as in the conventional unit.

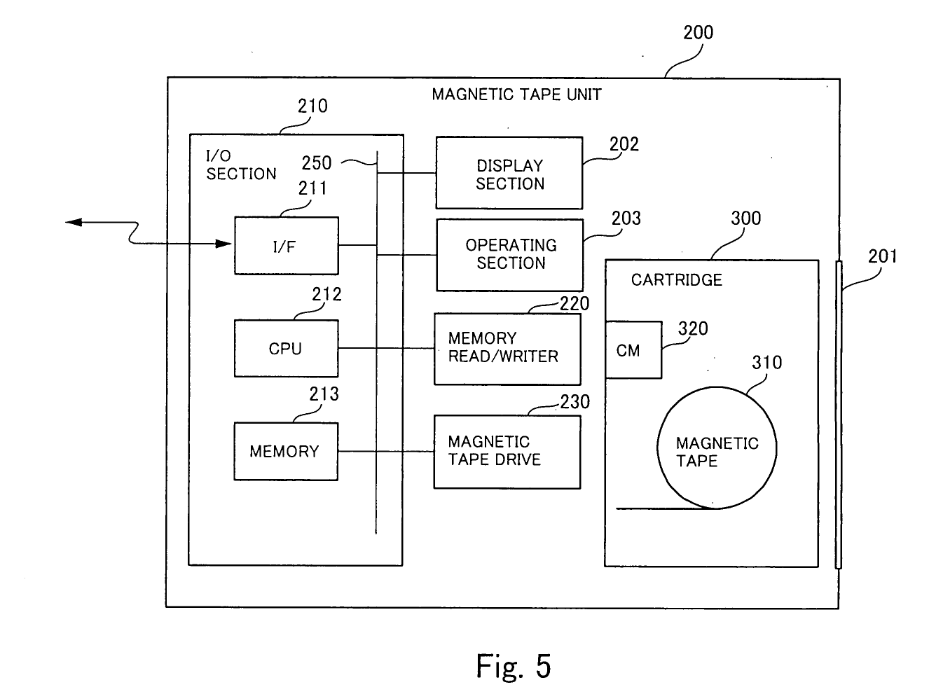

FIG. 5 is a block diagram of hardware of the magnetic tape unit whose outward appearance is shown in FIG. 4.

FIG. 5 shows the magnetic tape unit 200 in a state in which a cartridge 300 is loaded from the cartridge loading-opening 201 shown in FIG. 4. The magnetic tape unit 200 is also provided with the display section 202 and the operating section 203 shown in FIG. 4.

A magnetic tape 310 is accommodated in the cartridge 300. The cartridge 300 includes a cartridge memory (CM) 320. The cartridge memory 320 is a nonvolatile memory, and EEPROM is employed here. The cartridge memory 320 is read and written in a non-contact manner by a memory read/writer 220 which constitutes the magnetic tape unit 200.

The magnetic tape 310 accommodated in the cartridge 300 is of about 200GB for example, and has sufficiently large capacity greater than a total storage capacity of the magnetic tapes accommodated in the respective plurality of (five in the case of the example shown in FIG. 3) cartridges accommodated in the magazine 10 shown in FIG. 3. The magnetic tape 310 accommodated in the cartridge 300 shown in FIG. 5 is accessed by a magnetic tape drive 230.

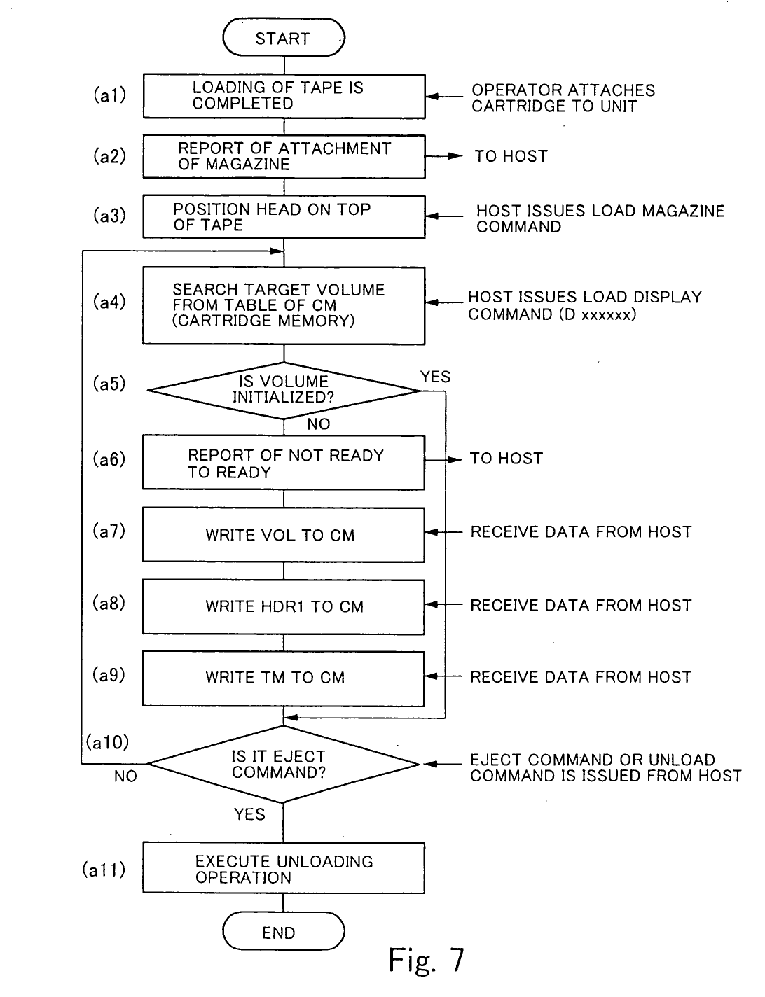

An I/O section 210 constituting the magnetic tape unit 200 shown in FIG. 4 includes an interface (I/F) 211 which is connected to the computer 100 shown in FIG. 4 and receives a request of access of the magnetic tape 310 from the computer 100, aCPU 212 for executing a later-described program (see FIGS. 7 to 9), and a memory 213 in which the program is stored. The I/O section 210 also includes a bus 250 which mutually connects the display section 202, the operating section 203, the memory read/writer 220 and the magnetic tape drive 230, in addition to the I/F211, the CPU 212 and the memory 213, and these elements constitute a microcomputer system.

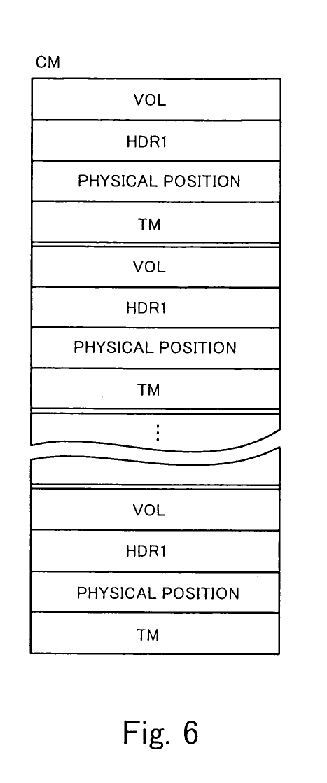

FIG. 6 illustrates contents of cartridge memory (CM) which is read and written in a program shown in FIGS. 7 to 9.

In the conventional magazine attaching type magnetic tape unit, as information that specifies each of a plurality of cartridges (plurality of magnetic tapes) accommodated in the magazine (here, the number of magnetic tapes is only one and thus the information specifies a plurality of virtual magnetic tapes), there are written: physical position information of the actual magnetic tape 310 shown in FIG. 5 where a volume name (VOL), a file name (HDR1) and data corresponding to the volume name (VOL) are written; and a tape mark (TM) indicating the end of the information concerning the volume name (VOL). This CM is not the magnetic tape itself. Here, information having a meaning as a breakpoint of information concerning one volume is called a tape mark (TM) likened to the magnetic tape.

Various information in addition to information concerning the volume is stored in the cartridge memory, but since such information has no direct relation with respect to the characteristic section of this invention, the illustration and explanation of such information will be omitted.

FIG. 7 is a flowchart of an initializing processing program which is executed by the CPU 212 in the I/O section shown in FIG. 5.

First, if an operator loads the cartridge 300 (see FIG. 5) into the magnetic tape unit and a notice informing the completion of load of the tape is received from the magnetic tape drive 230 (step a1), a host (computer 100 in FIG. 3) is informed that the magazine 10 (see FIG. 3) is loaded (step a2) In reality, only one cartridge 300 is loaded to the magnetic tape unit, but the host (computer 100) recognizes that this magnetic tape unit 200 is a conventional magazine attaching type magnetic tape unit.

If the host receives the report of the attachment of the magazine and issues “load magazine command”, the magnetic tape 310 is driven by the magnetic tape drive 230, and a magnetic head of the magnetic tape drive 230 is positioned on the top of the magnetic tape (step a3).

Next, if “load display command” issued by the host is received, a target volume is searched from the table (see FIG. 6) of the CM (cartridge memory 320) (step a4). Then, in step a5, it is judged whether the volume has already been initialized (step a5), and if the volume has already been initialized, the procedure is proceeded to step a10. Step a10 will be described later.

If it is judged that the target volume has not yet been initialized in step a5, the procedure is proceeded to step a6, and the host is informed of “NOT READY TO READY”, i.e., the host is informed of the fact that the state is shifted from a not ready state in which data can not be read or written to a ready state in which data can be read or written.

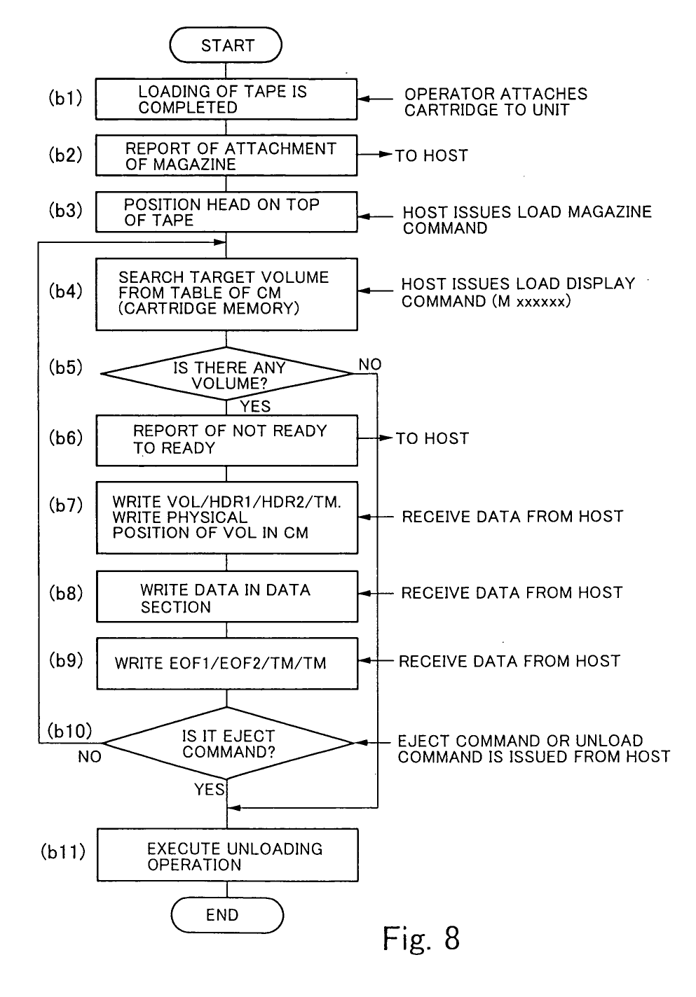

Then, data such as the volume name (VOL), the file name (HDR1) and the tape mark (TM) is sent from the host, and the data is written into the cartridge memory (CM) (steps a7, a8 and a9). The tape mark (TM) is written into the CM (see FIG. 6) while leaving, blank, the writing region in the physical position of the volume (VOL) which is written in step b7 in the writing processing routine into the tape shown in FIG. 8.

Next, the host issues “EJECT command” or “UNLOAD command”. The UNLOAD command is for commanding to rewind a loaded cartridge and to return the cartridge to the magazine in the case of a magnetic tape unit to which the magazine 10 is attached as shown in FIG. 3. The EJECT command is for commanding to bring a state in which all cartridges are accommodated in a magazine to a state in which the magazine itself can be taken out from the magnetic tape unit.

In step a10 in FIG. 7, it is judged whether the command which is currently issued from the host is the EJECT command or the UNLOAD command. If the command is the EJECT command, this means that the initialization of all the volumes (all the cartridges accommodated in the magazine shown in FIG. 3) has been completed and thus, the procedure is proceeded to step a11, and the unloading operation is executed. That is, if the magnetic tape is wound, the tape is rewound and the cartridge 300 is slightly sent out from the cartridge loading-opening 201.

On the other hand, if it is judged that the command which is currently received from the host is the UNLOAD command in step a10, the procedure is returned to step a4, the state is brought into a standby state until a next load display command is issued from the host, and if the next load display command is received from the host, processing of the steps after step a4 are repeated.

In this manner, by utilizing the cartridge memory (CM) 320, although the number of magnetic tape 310 is one in reality, the same initializing operation is smoothly carried out by the same command as that when the plurality of magnetic tapes in the plurality of cartridges accommodated in one magazine as shown in FIG. 3 are initialized.

FIG. 8 is a flowchart of a data writing processing program in which data is written into a magnetic tape.

The processing in steps b1 to b4 in the flowchart shown in FIG. 8 is the same as that of steps a1 to a4 of the flowchart shown in FIG. 7, and the same explanation will be omitted.

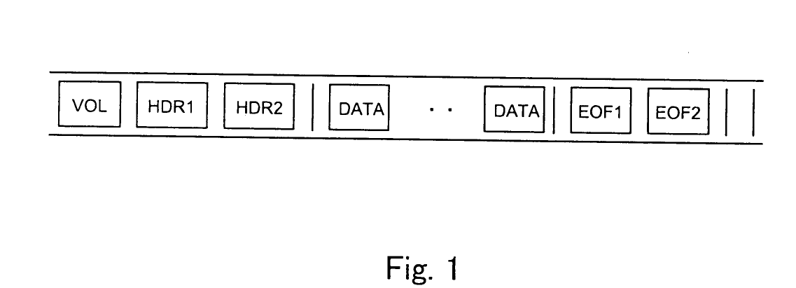

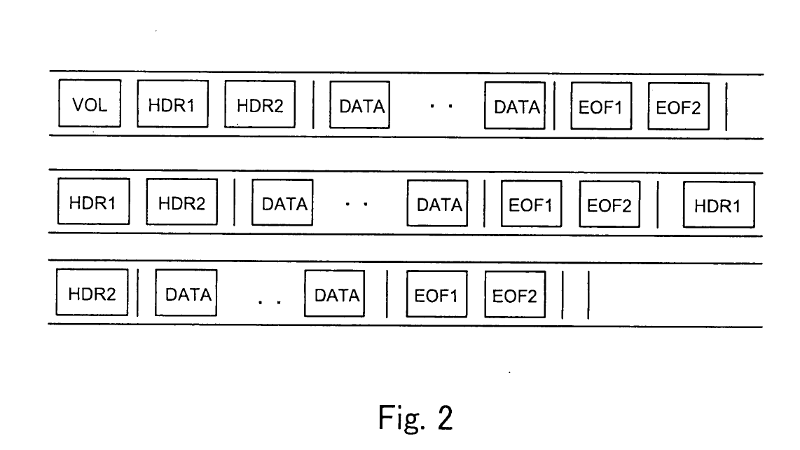

In step b5, it is judged from data on the CM (cartridge memory) whether a target volume exists in the magnetic tape. If the target volume does not exist, the procedure is proceeded to step b11, and the unloading operation is executed. If it is judged that the target volume exists in step b5, the procedure is proceeded to step b6, and the host is informed of “NOT READY TO READY”. Data from the informed host is received, and VOL/HDR1/HDR2/TM (see FIG. 1) is written into the magnetic tape 310, and the physical position of the VOL is written into the CM 320 (step b7). Then, data (DATA) to be written is received from the host, the DATA is written into the DATA section (see FIG. 1) of the magnetic tape 310 (step b8). Thereafter, data is received from the host and EOF1/EOF2/TM/TM is written (step b9).

Next, the EJECT command or UNLOAD command is issued from the host. Thus, the command is received and when it is the EJECT command, the unloading operation is carried out, and when the command is the UNLOAD command, the procedure is returned to step b4, a next load display command is waited from the host, and if the load display command is received from the host, the processing of the steps after step b4 is repeated.

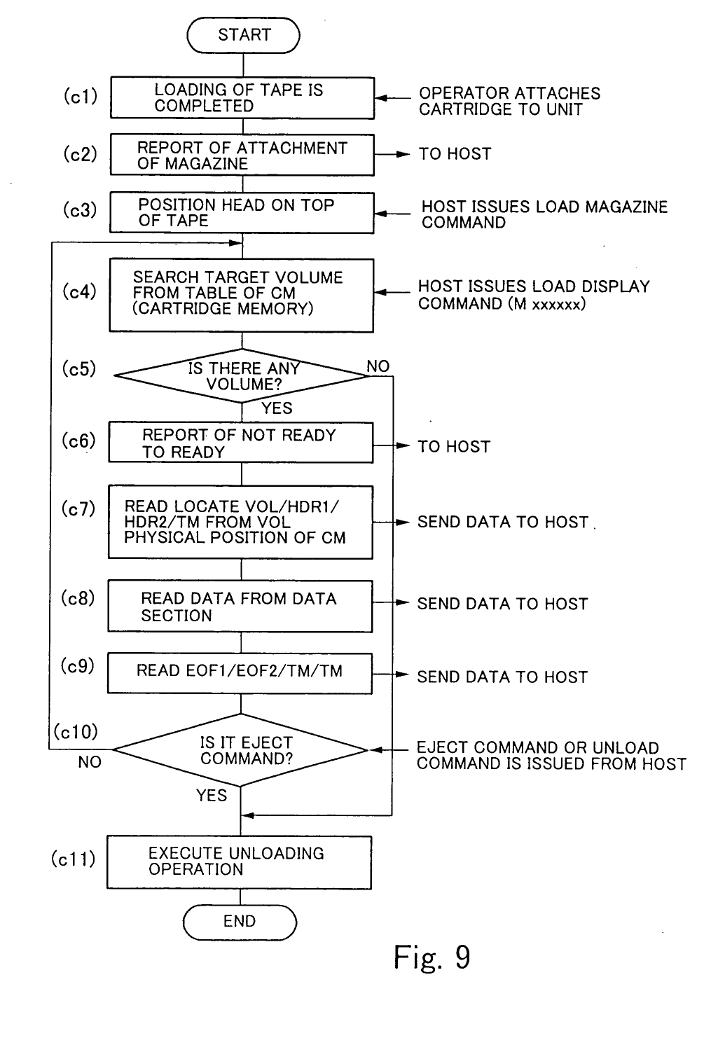

FIG. 9 is a flowchart of a data reading processing program in which data is read from the magnetic tape.

The processing in steps c1 to c4 in the flowchart shown in FIG. 9 is the same as that of steps a1 to a4 and b1 to b4 of the flowcharts shown in FIGS. 7 and 8, and the same explanation will be omitted.

In step c5, it is judged from data on the CM (cartridge memory) whether a target volume exists in the magnetic tape. If the target volume does not exist, the procedure is proceeded to step c11, and the unloading operation is executed. If it is judged that the target volume exists in step c5, the procedure is proceeded to step c6, and the host is warned of “NOT READY TO READY”. Then, a position (LOCATE) on the magnetic tape 310 is defined from the physical position of the target VOL which is written into the CM, VOL/HDR1/HDR2/TM of the target VOL is read from the magnetic tape 310, and the read data is sent to the host (step c7). Then, data (DATA) written there is read from the DATA section of the VOL on the magnetic tape 310 and the data is sent to the host (step c8) and EOF1/EOF2/TM/TM of the VOL is read from the magnetic tape and the EOF1/EOF2/TM/TM is sent to the host (step c9).

Next, the EJECT command or UNLOAD command is issued from the host. Thus, the command is received and when it is the EJECT command, the procedure is proceeded to step c11, the unloading operation is carried out, and when the command is the UNLOAD command, the procedure is returned to step c4, a next load display command is waited from the host, and if the load display command is received from the host, the processing of the steps after step c4 is repeated.

According to this embodiment, as described above, the host carries out the writing processing in FIG. 8 and the reading processing in FIG. 9 in the same sequence by the same command as those when the conventional magazine attaching type magnetic tape unit is accessed.

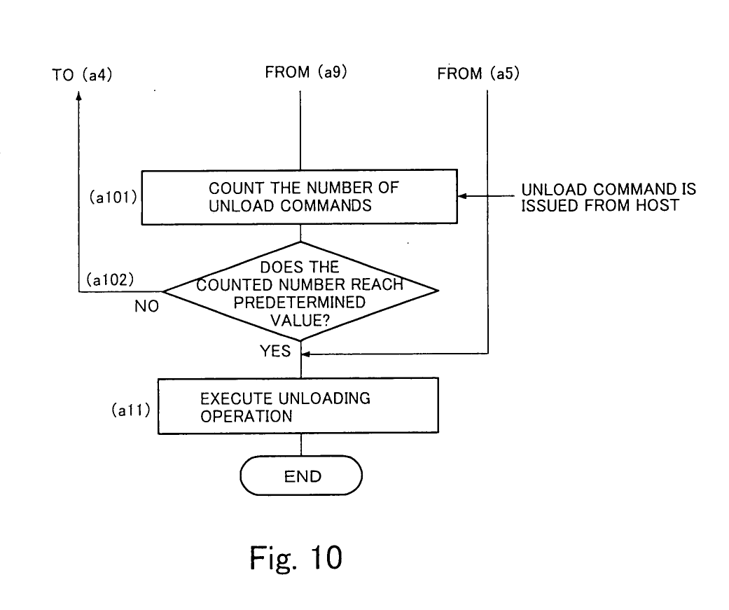

FIG. 10 is a partial flowchart that can be employed instead of steps a10 and a11 of the initializing processing program shown in FIG. 7.

Step a11 is the same as step a11 in FIG. 7.

In step a101, the host does not issue the EJECT command but issues the UNLOAD command only.

In step a101, the number of UNLOAD commands issued is counted, and in step a102, it is judged whether the number of UNLOAD commands issued reaches a predetermined value. This predetermined value corresponds to the number of cartridges accommodated in a magazine in the magazine attaching type magnetic tape unit.

If it is judged that the counted number reaches the predetermined value, the procedure is proceeded to step a11, the unloading operation is carried out. If it is judged that the counted number does not reach the predetermined value, the procedure is returned to step a4 shown in FIG. 7, a next load display command is waited from the host, and if the load display command is received from the host, the processing of the steps after step a4 is repeated.

When the partial flowchart shown in FIG. 10 is employed instead of steps a10 and a11 in the initializing processing shown in FIG. 7, the same partial flowchart as that shown in FIG. 10 is employed also for the data writing processing shown in FIG. 8 and the data reading processing shown in FIG. 9. That is, in this case, a partial flowchart in which steps a4, a5, a9, a11, a101 and a102 in the partial flowchart shown in FIG. 10 and in the above explanation are respectively replaced by steps b4, b5, b9, b11, b101 and b102 is employed instead of steps b10 and b11 in the flowchart shown in FIG. 8, and a partial flowchart in which steps a4, a5, a9, a11, a101 and a102 in the partial flowchart shown in FIG. 10 and in the above explanation are respectively replaced by steps c4, c5, c9, c11, c101 and c102 is employed instead of steps c10 and c11 in the flowchart shown in FIG. 9.

In this manner, the number of UNLOAD commands issued may be counted instead of waiting for the EJECT command, and when the number of UNLOAD commands issued reaches the predetermined value, the unloading operation may be carried out in correspondence to software of the host. Alternatively, the unloading operation may be carried out in response to the EJECT command and the unloading operation may be carried out when the number of UNLOAD commands reaches the predetermined value. With such a configuration, the magnetic tape unit can satisfy the requirement irrespective of type of the software of the host.

In step a3 in FIG. 7, step b3 in FIG. 8 and step c3 in FIG. 9, if the host issues the load magazine command, the magnetic head is positioned on the top of the magnetic tape. However, it is indispensable here to always position the magnetic heat on the top of the magnetic tape and thus, the magnetic head may be positioned on the top of the magnetic tape without waiting for the load magazine command from the host.

1. A magnetic tape unit to which a cartridge accommodating a magnetic tape is detachably attached and which accesses the magnetic tape in accordance with an access request from a host, wherein
the cartridge accommodates the magnetic tape and includes a cartridge memory which stores information in a nonvolatile and rewritable manner,
the magnetic tape unit comprising:
a magnetic tape drive which accesses the magnetic tape;
a memory read/writer for accessing the cartridge memory; and
an access-controlling section which allows the cartridge memory to store management information of a plurality of volumes using the memory read/writer, and in which based on the management information, a LOAD command of the cartridge from the host is replaced by a command for accessing a region corresponding to a volume of a virtual cartridge which receives the LOAD command from the host in the magnetic tape accommodated in an actual cartridge loaded in this magnetic tape unit, the access-controlling section allowing the magnetic tape drive to access the magnetic tape accommodated in the actual cartridge.

2. The magnetic tape unit according to claim 1, wherein the access-controlling section remains a state in which the magnetic tape is loaded in the actual cartridge in accordance with an UNLOAD command of the cartridge from the host, and the access-controlling section brings this state into a state in which the actual cartridge can be taken out in accordance with an EJECT command from the host.

3. The magnetic tape unit according to claim 1, wherein the access-controlling section remains a state in which the magnetic tape is loaded in the actual cartridge until the number of UNLOAD commands from the host reaches a predetermined value, and the access-controlling section brings this state into a state in which the actual cartridge can be taken out if the number of UNLOAD commands from the host reaches the predetermined value.
